(19) United States
(12) Patent Application Publication
(10) Pub. No.: US 2008/0061010 A1
(43) Pub. Date: Mar. 13, 2008

(54) Filter System for Ponds and Larger Aquariums

(76) Inventor: Darren Christopher Tom, San Jose, CA (US)

Correspondence Address: CENTRAL COAST PATENT AGENCY, INC, 3 HANGAR WAY SUITE D, WATSONVILLE, CA, 95076, US

(21) Appl. No.: 11/735,917

(22) Filed: Apr. 16, 2007

Related U.S. Application Data
(60) Provisional application No. 60/842,886, filed on Sep. 7, 2006.
(60) Provisional application No. 60/850,201, filed on Oct. 6, 2006.

(51) Int. Cl. B01D 29/00

(52) U.S. Cl. 210/767; 210/167.21; 210/167.01; 210/170.02

(57) ABSTRACT

A filter system includes a filter compartment enclosing a filtering media, a downward-facing intake into the filter compartment, the intake submerged below the surface of the fluid and elevated above the floor of the fluid container, and an outlet in the filter compartment for connection to a suction source, so that fluid is drawn upward into the downward-facing intake and through the filtering media.

### CROSS-REFERENCE TO RELATED APPLICATIONS

This application claims priority to U.S. provisional patent application Ser. No. 60/842,886, entitled “Submerged Pond Filter with Algae and Large Particle Debris Exclusion” filed on Sep. 07, 2006, and U.S. provisional patent application Ser. No. 60/850,201, entitled “Submerged Pond Filter with Multi-Purpose Footprint” filed on Oct. 06, 2006, both of which are incorporated herein at least by reference.

### BACKGROUND OF THE INVENTION

1. Field of the Invention

The present invention is in the field of filtering equipment for ponds and large aquariums and pertains particularly to a filtering system that resists algae and clogging with particulate matter.

2. Discussion of the State of the Art

Maintaining clear water in aquariums and ponds is one of the most important priorities. Clear oxygenated water promotes the health of fish and other wildlife that may inhabit a pond or aquarium and helps to maintain aesthetic appeal. Efficient removal of small particles is a critical component of any filtering system when filtering cloudy water. In many filter systems however; premature filter media clogging significantly reduces the filtering system's efficiency, leaving the water cloudy even with frequent media cleaning intervals.

Current filter designs include exposed upward or side facing water intakes. Upward and side facing water intakes may be susceptible to algae growth on the water intake. This algae growth may easily spread to the filter media immediately behind the intake grill, reducing filter capacity even while the water isn't flowing through the filter. Another problem is that large particles (aquatic soil and other debris) stirred up by moving water and marine life may settle on upward facing water intakes or may float into side facing intakes clogging the filter system and reducing efficiency. Current designs do not allow the use of the space immediately above or beside the intake since this would impede the flow of water into the filter. The exposed intake area may also be an unattractive part of the visual landscape.

What is clearly needed is a filtering system for ponds and aquariums that can resist algae growth and particulate intake more efficiently than can current filter systems.

### SUMMARY OF THE INVENTION

In one embodiment of the invention a filter system is provided comprising a filter compartment enclosing a filtering media, a downward-facing intake into the filter compartment, the intake elevated above the bottom of the pond or aquarium, and an outlet in the filter compartment for connection to a pump. The outlet is positioned to draw water upward into the downward-facing intake and through the filtering media.

In one embodiment the support surface is the bottom of a pond, and in another the bottom of an aquarium. In another embodiment the spacers are adjustable to adjust height of the downward-facing intake above the bottom of the pond or aquarium. In some embodiments there may be a cover positioned over the filter compartment, the cover including the downward facing intake.

In one embodiment, the support surface is the water itself. The filter system is attached to a floating device. The downward-facing intake is suspended from the device at an elevation above the bottom of the pond or aquarium. In some embodiments, the suspension can be shortened or lengthened to adjust the height of the downward-facing intake above the bottom of the pond or aquarium. In other embodiments, the buoyancy of the floating device may be changed to adjust the height of the downward-facing intake above the bottom of the pond or aquarium.

In some embodiments there is a grate or a screen covering the downward-facing intake. In some cases the downward-facing intake in the cover may include at least one connector sleeve that snaps into at least one opening in the filter compartment leading to the filter media.

In many embodiments, the area immediately above the filter compartment may serve a secondary functional or aesthetic purpose. In some embodiments the top of the compartment may be a flat surface on which decorative or functional objects may be placed. In other embodiments the area above the compartment may be formed into elements for camouflaging the filter system. The elements may represent an animal, plant, rock formation, landmark, natural phenomenon, landscape, vehicle, building, icon, logo, human, artistic sculpture, piece of art, or any combination of these. In some embodiments, the water output from the pump may be part of the camouflaging element in the form of a waterfall, fountain or other complementary water feature. In other embodiments, the functional part of the filter compartment shares a common fastening mechanism with many different camouflaging elements, thereby enabling easy customization of the secondary aspects of the filter system.

In another aspect of the invention, a method is provided for filtering, comprising the acts of (a) submerging a filter system including a filter media compartment, an intake and an outlet with the filter intake facing downward, (b) providing elevation of the intake above the pond or aquarium bottom, (c) connecting the outlet to an ultraviolet sterilizer, (d) connecting the ultraviolet sterilizer to a pump, (e) powering on the ultraviolet sterilizer, and (f) powering on the pump to draw water upward through the filter system (intake, filter media, outlet) and ultraviolet sterilizer.

In one embodiment in act (b) the support surface is the bottom of a pond. In another embodiment in act (b) the support surface is the bottom of an aquarium. In another embodiment in act (b) the support surface is the water. In another embodiment in act (b) the intake is integrated into a cover that attaches over the filter media compartment. In some embodiments the spacers are adjustable for height. In other embodiments the ultraviolet sterilizer is omitted in acts (c) and (d), so that the outlet is connected directly to the pump. In some embodiments, acts (a), (b), (c), and (d) are integrated into a single physical unit that is energized by a single power source for acts (e) and (f). In other embodiments, acts (a), (b), (c), and (d) are separate physical units connected to hoses or tubes and functionality for (e) and (f) may be provided by external power supplies.

### BRIEF DESCRIPTION OF THE DRAWING FIGURES

FIG. 1 is a side view of a filter system according to an embodiment of the present invention.

FIG. 2 is a top view of the filter system of FIG. 1.

FIG. 3 is a bottom view of the filter system of FIG. 1.

FIG. 4 is a side view of the filter system of FIG. 1 connected to an external ultraviolet (UV) sterilizer and pump.

FIG. 5 is a side view of an alternate embodiment of the filter system of FIG. 1 that integrates the UV sterilizer and pump into a single unit.

FIG. 6 is a side view of a filter system according to another embodiment of the invention.

FIG. 7 is a top view of the filter system of FIG. 6.

FIG. 8 is a bottom view of the filter system of FIG. 6.

FIG. 9 is a side view of the filter system of FIG. 6 connected to an external ultraviolet (UV) sterilizer and pump.

FIG. 10 is a side view of an alternate embodiment of the filter system of FIG. 6 that integrates the UV sterilizer and pump into a single unit.

FIG. 11 is a side view of the filter system of FIG. 1 used as a plant stand.

FIG. 12 is a side view of the filter system of FIG. 6 used as a plant stand.

FIG. 13 is a side view of the filter system of FIG. 1 camouflaged as a turtle.

FIG. 14 is a side view of the filter system of FIG. 6 camouflaged as a pyramid.

FIG. 15 is a side view of the filter system of FIG. 5 camouflaged as a submarine.

FIG. 16 is a side view of the filter system of FIG. 5 camouflaged as a boat.

### DETAILED DESCRIPTION

The inventor provides an improved filtering system for ponds and aquariums. The filtering system is described in enabling detail according to various embodiments described below in accordance with the illustrations. In all figures, solid arrows represent water flowing into and out of the embodiment and dotted arrows represent water flow within the embodiment.

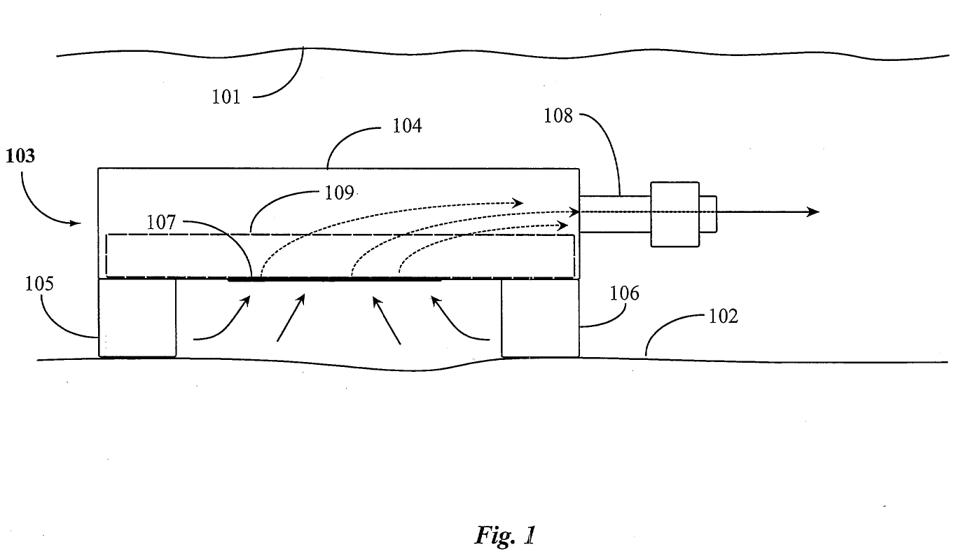

FIG. 1 is a side view of a filter system 103 according to an embodiment of the present invention. Filter system 103, also referred to herein as filter 103, is illustrated in a submerged position in a pond. Filter 103 rests, in this example, on a pond floor 102. Filter 103 is submerged completely in the pond as illustrated by a top water line 101.

Filter 103 includes a filter compartment 104. Compartment 104 is adapted to contain filter media 109 such as charcoal, plastic mesh media, or other suitable water-filtering media. Filter compartment 104 is generally a hollow enclosure having four sides and a top and bottom.

Filter compartment 104 in this exemplary embodiment is strategically elevated above pond floor 102 a specific distance as governed by filter stands 105 and 106. Filter stands 105 and 106 may be made of plastic or other durable polymers, or of other suitable material, and may be constructed so as to each extend the width of compartment 104 for stability. In one embodiment, four stands may be provided instead of two stands 105 and 106, one at each corner of the compartment, and in other embodiments other configurations may be used. The purpose is to raise the filter compartment above the bottom of the pond by a distance sufficient to allow water flow into intake 107. The stands may also be structurally designed to enable water to flow through them similar to a wire cage design or a plastic crate with multiple openings in all sides, to minimize impediment to water flow. In one embodiment, stands 105 and 106 may be solid rectangular components attached to compartment 104 by nut and bolt, snap-on, or some other fastening mechanism.

An important feature of stands 105 and 106 is to elevate compartment 104 sufficiently above pond floor 102 so that gravity may play a part in preventing larger particulate matter from entering intake 107. In one embodiment, stands 105 and 106 may be adjustable in height. The exact height that compartment 104 is elevated above pond floor 102 will depend in part on the nature of the pond itself. For example, if the pond has considerable sediment that may be disturbed by fish, frogs and other wildlife, the height desired might be greater than that in a pond that has less sediment or other particulates on the bottom. The angle of intake 107 in relation to the floor 102 may vary from 0 degrees (parallel to the floor) to less than 90 degrees (nearly perpendicular to the floor) without departing from the scope of the invention.

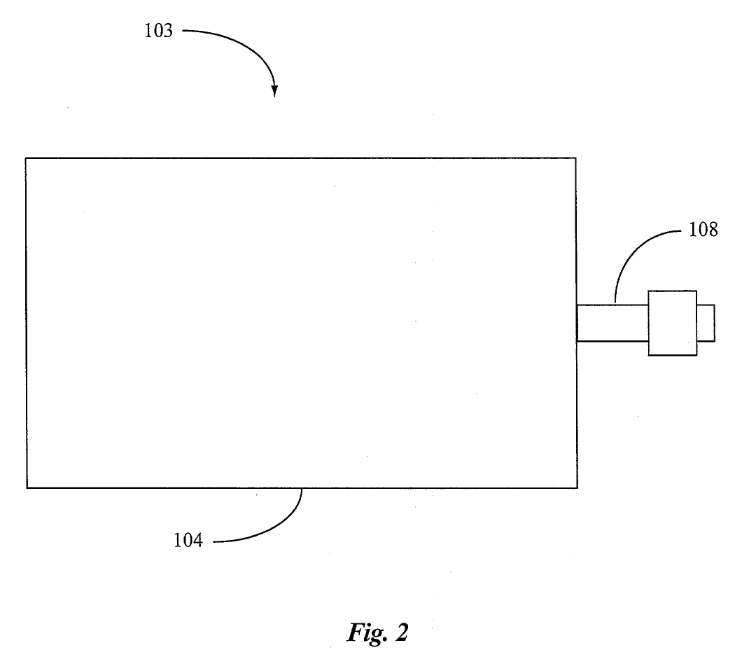

FIG. 2 is a top view of filter 103. In this embodiment, the top is a solid flat surface. The space immediately above and to the side of filter 103 is available for uses secondary to filtering. Some examples of secondary uses will be discussed in detail below. In this example, filter compartment 104 is rectangular, however other geometric configurations may be practical, such as triangular, oval, annular, disc-shaped, and so on. A prototype known to and used by the inventor has a rectangular configuration with respect to the construction of filter compartment 104. In one embodiment, compartment 104, which constitutes the main filtering body, may be made of plastic or other durable polymers. Other durable materials may also be used to construct filter compartment 104 like aluminum, ceramic, steel, and so on.

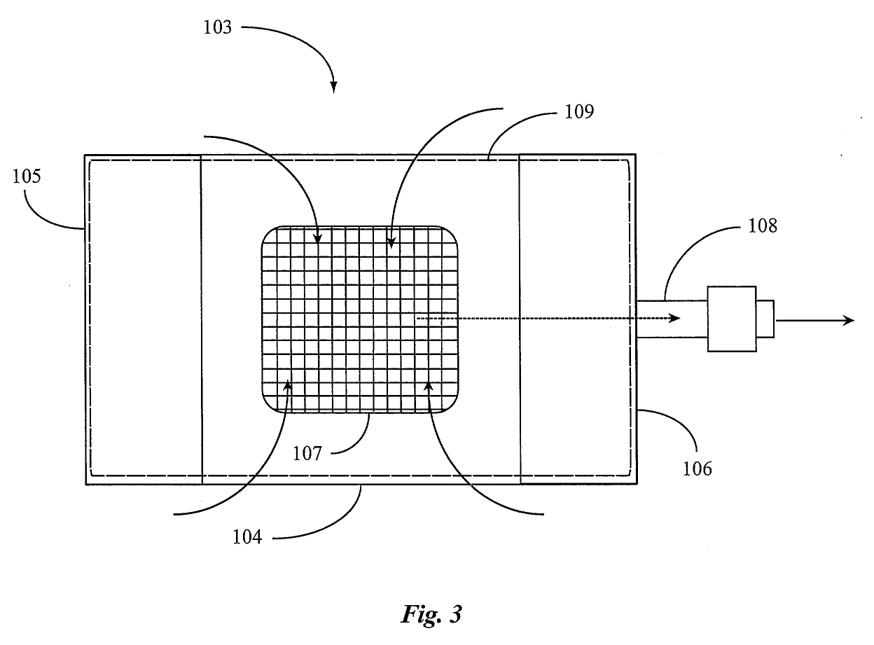

FIG. 3 is a bottom view of filter 103. Filter compartment 104 has an intake 107 adapted to enable intake of water into the filter compartment directing the water through the filter media 109 under suction pressure from a pump. Filter media 109 may occupy more or less space in filter compartment 104 without departing from the scope of the invention. Moreover, media 109 may be enclosed in its own compartment. Filter stands 105 and 106 provide stable structures to elevate filter compartment 104 off of the pond floor as described earlier. The exact position of and size of intake 107 may vary according to filter design and capacity. Intake 107 is strategically located on the downward facing side of filter media compartment 104. In this particular configuration, the strategic location of intake 107 prevents sunlight from hitting it, thereby inhibiting algae growth on or around the intake. Water flows up into intake 107 from below the filter media as indicated by the directional arrows. This feature aided by the elevation of compartment 104 allows larger particles and debris to settle by gravity before being drawn into intake 107. A coarse screen or grate can be added to keep objects of neutral buoyancy from entering intake 107. The course screen is not absolutely required to practice the invention.

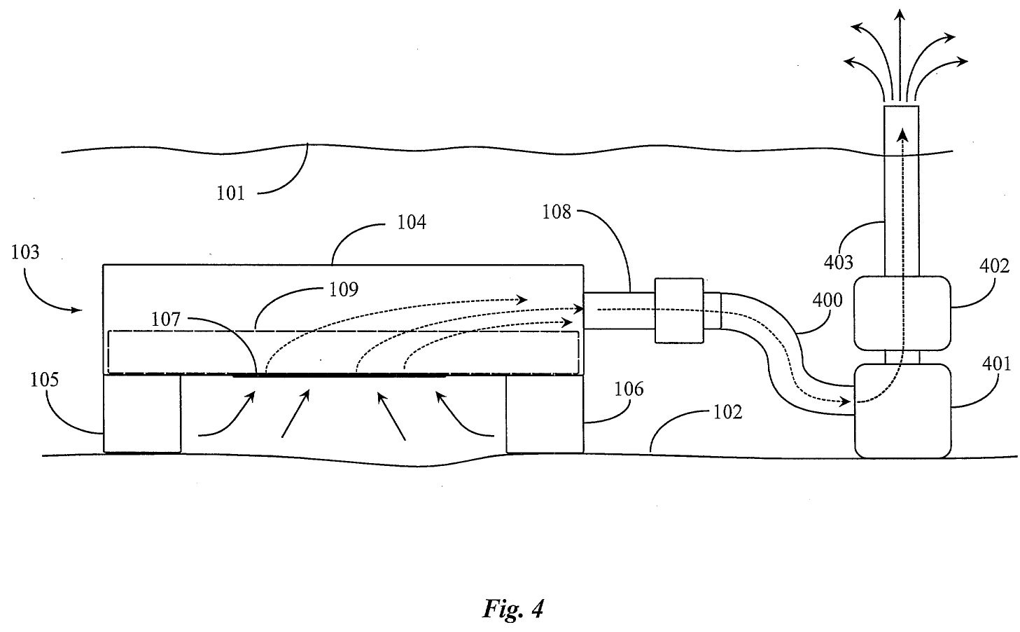

In FIG. 4, filter pump 402 is connected to filter 103 by means of a hose or similar connector 400 and is associated in line with an ultraviolet sterilizing unit 401, which may be optional in some embodiments. Compartment 104 includes an outlet 108 that is adapted to enable water that has been filtered through the filter media inside compartment 104 to egress toward the filter pump 402 through an egress line 400. Outlet 108 may be constructed of poly vinyl chloride (PVC), copper, brass, or of any other suitable material. Outlet 108 may also include tubes and fittings that enable attachment of a hose or a waterline (400) leading to the pump that induces water flow into the filter. In this example, outlet 108 is mounted in a sidewall of compartment 104. Finally, water egresses pump 402 through line 403. Line 403 may be a waterspout or it may be connected to some other pond circulation equipment without departing from the scope of the invention.

A prototype built by the inventor generally conforming to the architecture of filter 103 in the configuration illustrated in FIG. 4 was empirically tested under normal and adverse pond conditions and it was found that the pond water stayed cleaner much longer than it did using filter systems of standard design having side or upward facing intakes. As a result, filter media had a longer life and had to be changed less frequently.

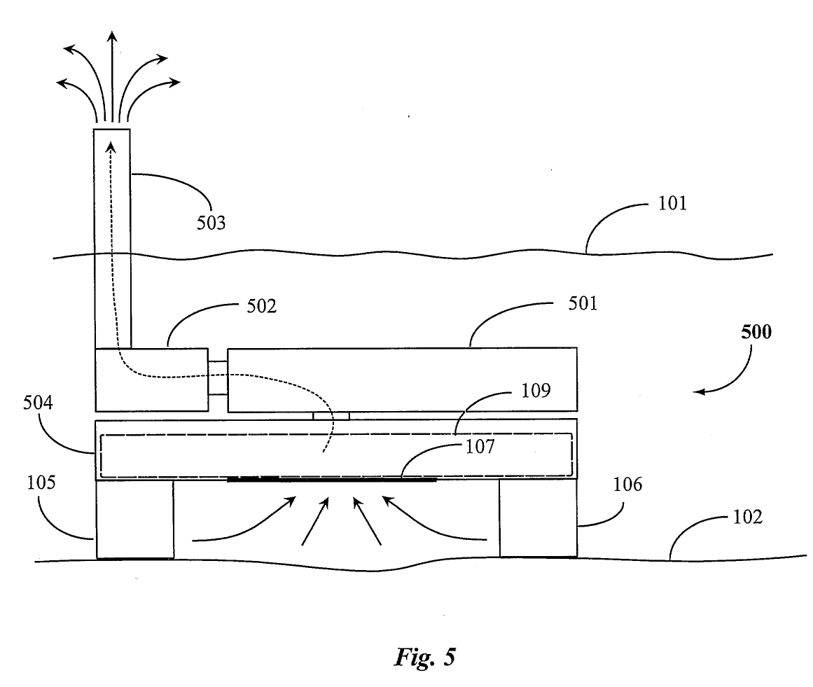

FIG. 5 is a side view of a filter system 500 according to another embodiment of the invention. This embodiment is an “integrated system” where a pump and optional UV sterilizer are built into the filtering system instead of being maintained separately and is functionally equivalent to the combination of all elements shown in FIG. 4. Filter system 500 has all of the previously described components of filter system 103 described further above plus pump 502 and UV sterilizer 501 integrated into a single physical unit. A filter compartment 504 containing filter media 109, filter stands 105 and 106 and an intake 107 that uses gravity, shading, and a course screen to reduce intake of larger particles and debris. The course screen is not absolutely required to practice the invention. Space immediately above and beside filter system 500 is available for secondary uses.

Filter system 500 includes an onboard filter pump 502 mounted on top of the filter compartment 504 such that water may flow into intake 107, through the filter media 109 in compartment 504, through UV sterilizer 501 and pump 502 to water egress 503 that functions as a fountain head in this embodiment. Device 503 may be plumbed directly into the pump and is configured to rise vertically above waterline 101 to produce the shower spray effect. Egress 503 may be plumbed differently and not depart from the scope of the invention.

Other embodiments similar to filter system 500 may integrate the pump and/or UV sterilizer into stands 105 and 106. The exact positions of outlet 503, pump 502, and UV sterilizer 501 may vary without departing from the scope of the invention. Some embodiments may omit the UV sterilizer.

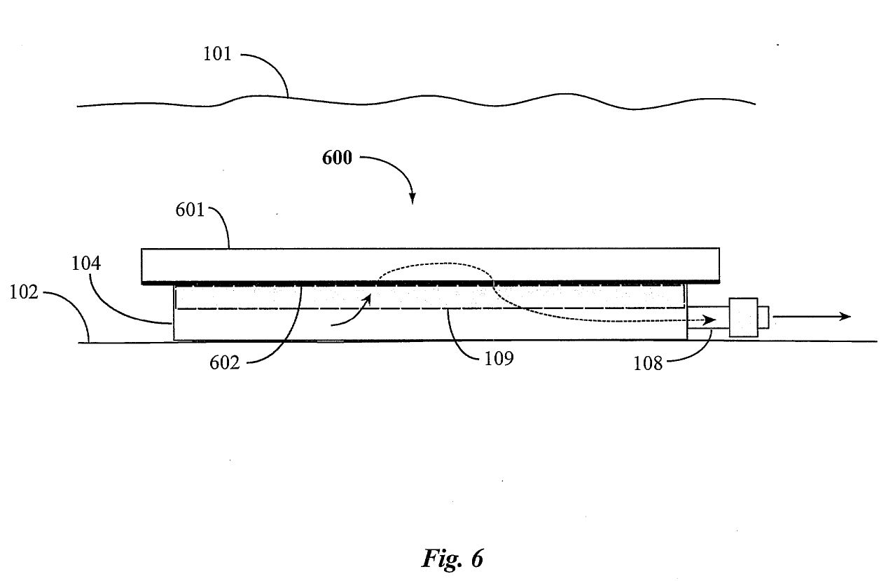

FIG. 6 is a side view of a filter system 600 according to another embodiment of the invention. Filter system 600 is illustrated in a submerged position below water line 101 inside a pond in this example. It will be apparent to one with skill in the art that filter system 600 and the filter system 103 described above can also be used in an aquarium, water tank, or other systems that hold water and where water clarity is important. In this example, the system is resting on pond floor 102.

Filter system 600 has a filter compartment 104, which may be analogous to the filter compartment in filter system 103 described further above. Filter compartment 104 is adapted to contain the filter media 109. In this example, filter system 600 does not have any filter stands used to elevate it above a pond floor 102. An intake cover 601 is provided to fit over filter compartment 104 in this example. Intake cover 601 has 4 sides and a solid top in this example. The rectangular dimensioning of intake cover 601 enables the cover to fit over the rectangular profile of compartment 104 such that there is ample overhang around the perimeter of compartment 104. The overhang area all around compartment 104 serves as a water intake 602 in this embodiment. The top of compartment 104 has one or more grated openings (not illustrated) into the filter media 109 so that water drawn into intake 602 enters the filter media for filtering generally along the direction of the arrows indicating external and internal flow.

Filtered water flows through outlet 108 in the same fashion described above with respect to FIG. 1. In this case, the height of compartment 104 serves as a standoff that keeps intake 602 sufficiently elevated above pond floor 102. Intake cover 601 may be adapted with retainer clips to enable attachment and removal of the cover from filter compartment 104. In a preferred embodiment, water may flow into the cover and subsequently through openings in the top of compartment 104 so that it may pass through the filter media 109 on the way out through outlet 108.

The principles that reduce premature clogging and subsequent filter inefficiencies are the same for both filter systems 103 and 600. Gravity prevents larger particles from being draw into intake 602 and a course screen (not illustrated) may be provided to cover the intake area to help insure that debris with neutral buoyancy does not get in. The course screen is not absolutely required to practice the invention. Likewise, the overhang shades the downward facing intake so that is relatively safe from algae growth even if the filter system is placed in direct sunlight in the pond. The construction of filter system 600 may also include filter stands if desired.

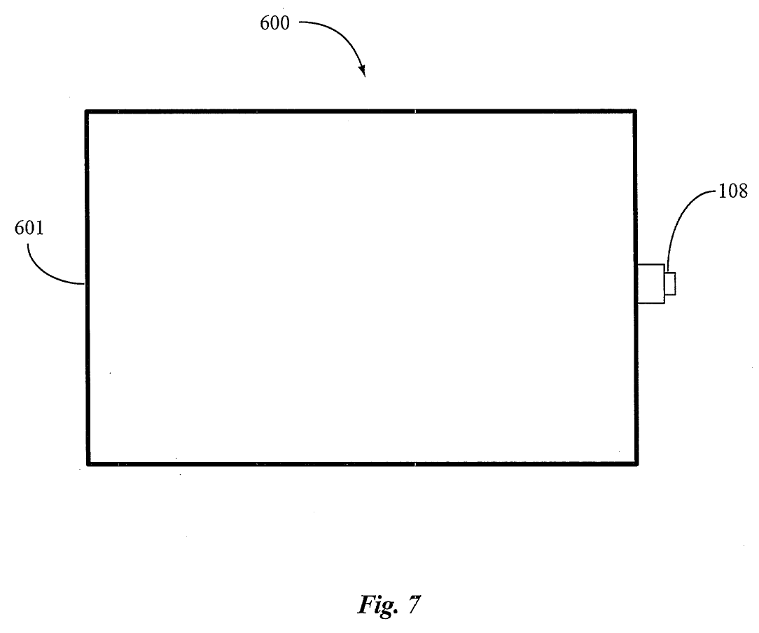

FIG. 7 is a top view of the filter system of FIG. 6. In this embodiment, intake cover 601 has 4 solid walls and a solid flat top. The space immediately above and to the side of filter 600 is available for uses secondary to filtering.

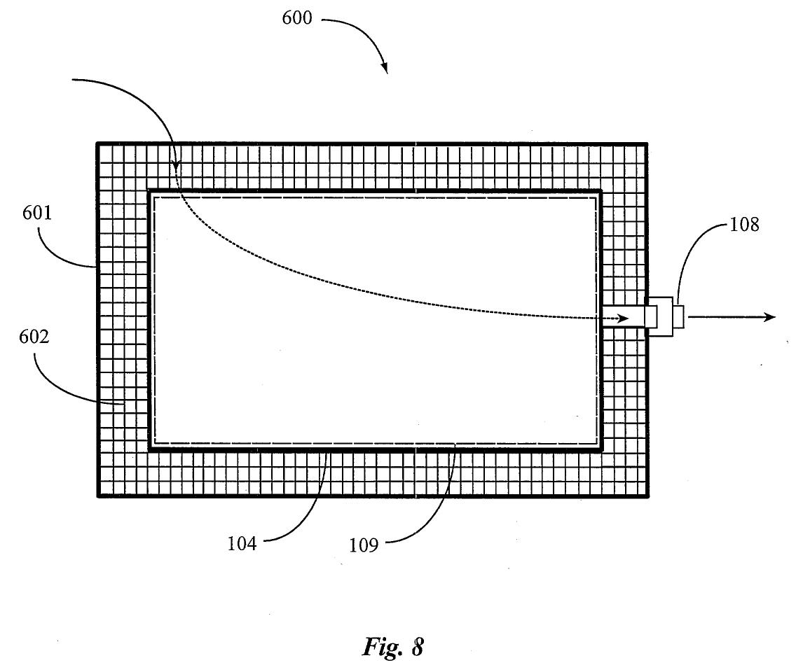

FIG. 8 is a bottom view of the filter system of FIG. 6. In this view, intake 602 extends completely around filter compartment 104 and is additionally protected from larger particles by a course screen. When intake cover 601 is attached to filter compartment 104, the inside edges of intake 602 align closely to the walls of compartment 104 so that there is little or no gap between the intake edge and the compartment wall. In this example, one or more grated or screened openings may be provided through the top of compartment 104 generally around the intake region so that water may enter into media 109 from all sides of the filter system. This is not absolutely required in order to practice the invention. The actual intake area may cover one, two or three sides instead of four. There may be a specific pattern of intake coverage that includes some of but not all of the area shown in this example. In this example, the perimeter of intake cover 601 and filter compartment 104 are shown as rectangular. Any practical geometric shape may be possible for 601 and 104 as long as the inner edge of intake 602 fits snugly with the perimeter of filter enclosure 104. There are many differing design possibilities, some of which may come into play depending on pond size and other factors.

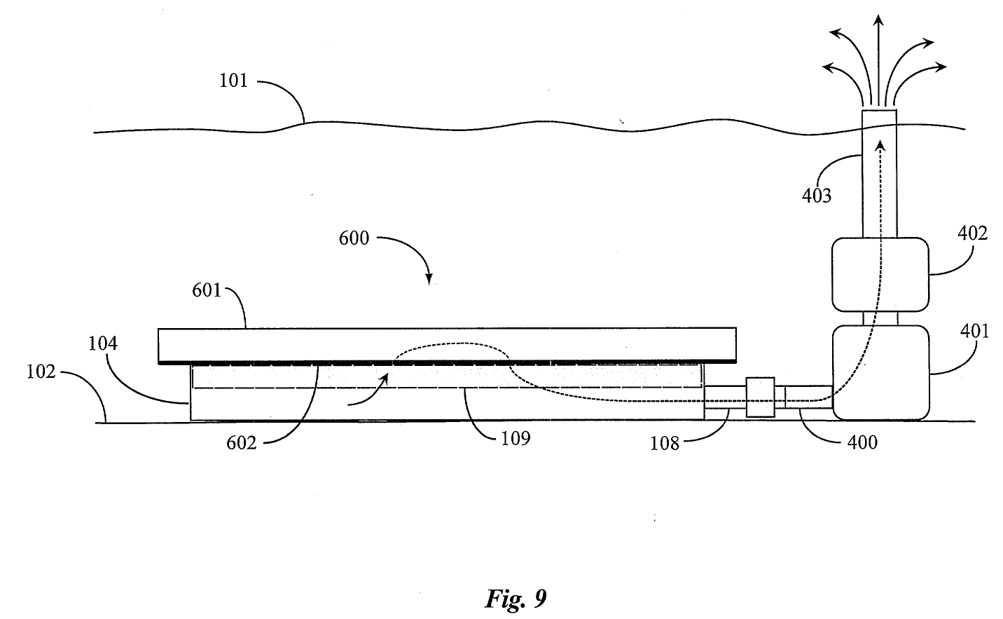

FIG. 9 is a side view of filter system 600 connected to an external UV sterilizer 401 and pump 402. Outlet 108 is connected by means of a hose or similar connector 400 to UV sterilizer 401, which is inline before pump 402. Water is pumped out of pump 402 through egress line 403 as described further above.

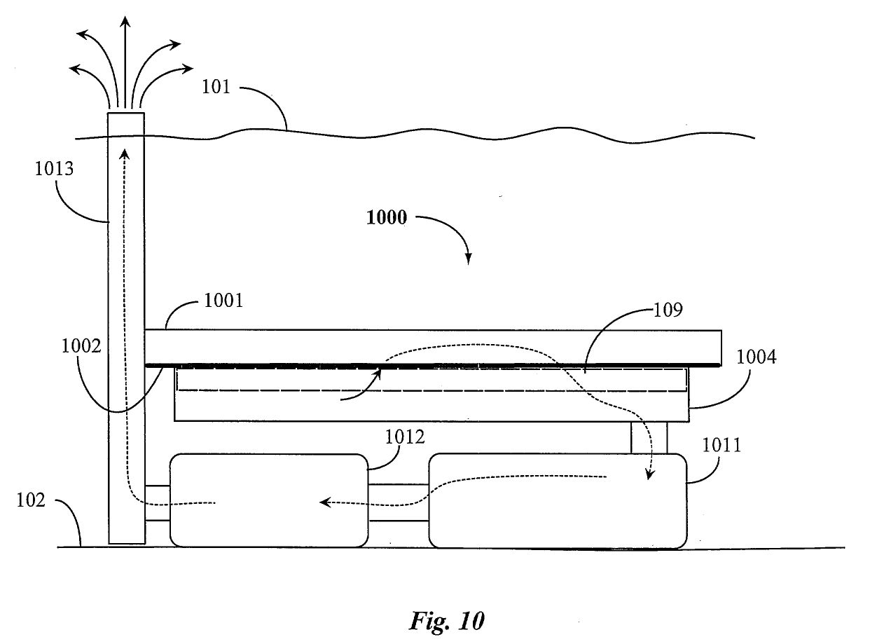

FIG. 10 is a side view of a filter system 1000 according to another embodiment of the invention. This embodiment is an “integrated system” where a pump and optional UV sterilizer are built into the filtering system instead of being maintained separately and is functionally equivalent to the combination of all elements shown in FIG. 9. Filter system 1000 has all of the previously described components of filter system 600 described further above plus pump 1012 and UV sterilizer 1011 integrated into a single physical unit. System 1000 has cover 1001 that may be analogous to cover 601 in filter system 600 and a filter compartment 1004 containing filter media 109. Similar to cover 601, cover 1001 has intake 1002 built into the overhang surrounding the filter compartment 1004. Downward facing intake 1002 uses gravity, shading, and a course screen to reduce intake of larger particles and debris. The course screen is not absolutely required to practice the invention. Space immediately above and beside filter system 1000 is available for secondary uses.

In this integrated example, water is drawn into the system through intake 1002 with pump 1012 powered on. The water is filtered through filter media 109 and exits compartment 1004 via UV sterilizer 1011 and eventually through pump 1012 to egress 1013. In this case the egress route 1013 for filtered water is a vertically disposed tube, which may function as a water fountain when operated. Egress 1013 may be plumbed differently and not depart from the scope of the invention.

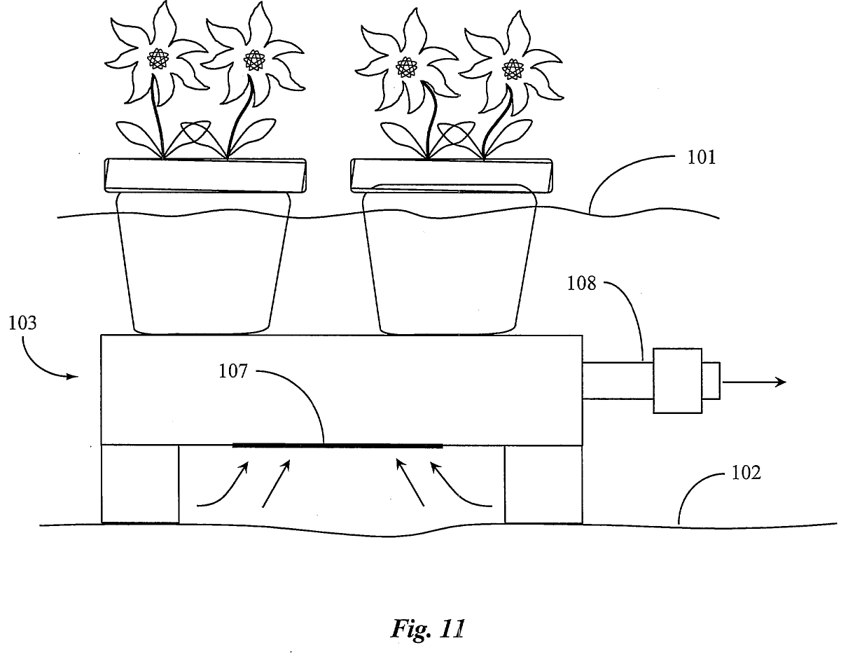

FIG. 11 is a side view of filter system 103 performing a secondary use as a plant stand. Filter system 103 is shown in this embodiment submerged in a pond beneath water line 101 resting on pond floor 102. In this example, the downward facing intake design of filter system 103 enables the full use of the top of system 103 as a place to put functional or decorative objects without obstructing the water flowing into intake 107 and out of egress 108. In one embodiment the top of filter system 103 is ridged or grooved to facilitate the attachment of functional devices that may include lights, heaters or food dispensers. In other embodiments, a series of interconnected elevated shelves attached to the top of filter system 103 may provide several locations for the placement of items. Another embodiment of filter system 103 is reinforced and tall enough so that its top is just above the surface of the water, so that it may function as a stepping-stone or pathway across the pond.

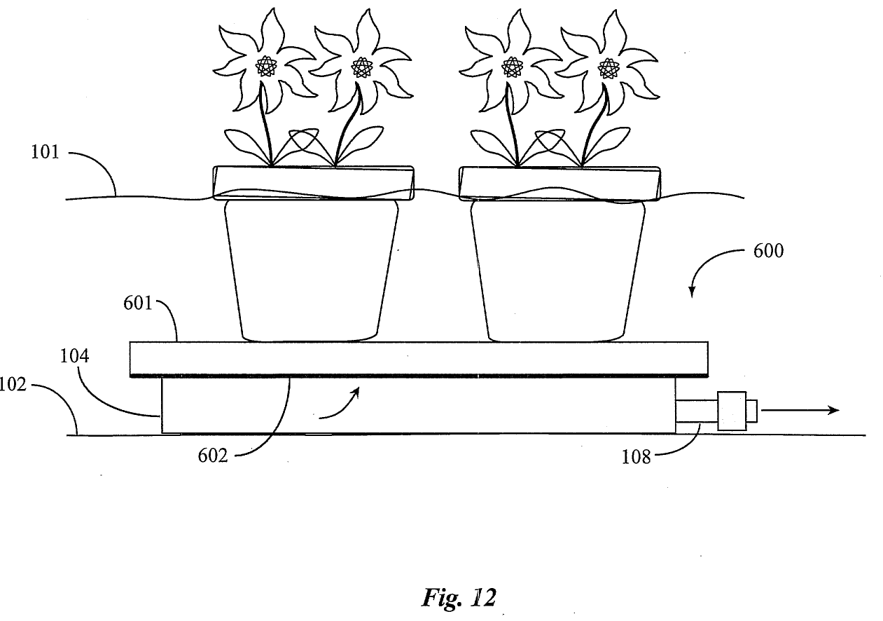

FIG. 12 is a side view of filter system 600 performing a secondary use as a plant stand. Filter system 600 is shown in this embodiment submerged in a pond beneath water line 101 resting on pond floor 102. In this example, the downward facing intake design integrated into cover 601 of filter system 600 enables the full use of the top of system 600 as a place to put functional or decorative objects without obstructing the water flowing into intake 602 and out of egress 108. In one embodiment cover 601 of filter system 600 is ridged or grooved to facilitate the attachment of functional devices that may include lights, heaters or food dispensers. In other embodiments, a series of interconnected elevated shelves attached to cover 601 may provide several locations for the placement of items. Another embodiment of filter system 600 is reinforced and tall enough so that its top is just above the surface of the water, so that it may function as a stepping-stone or pathway across the pond.

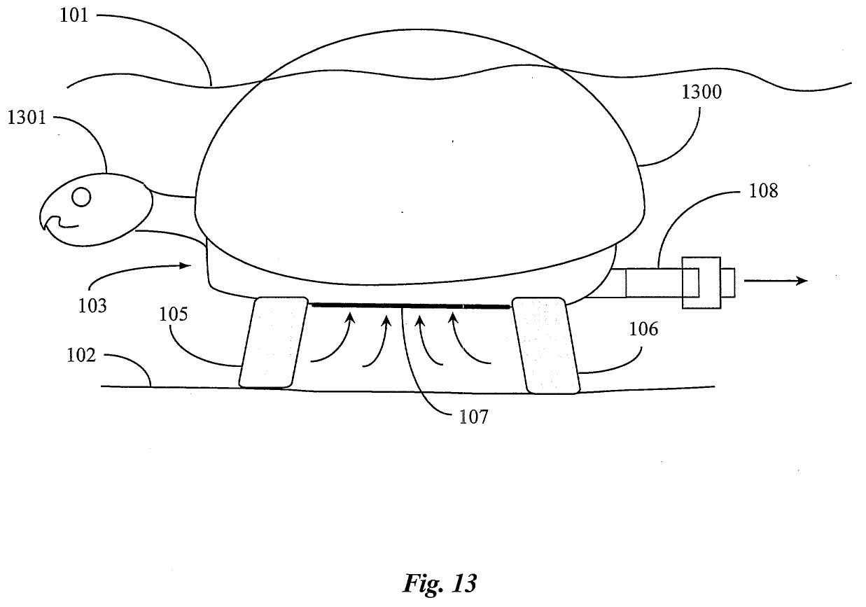

FIG. 13 is a side view of yet another embodiment of the invention. Filter system 103 is performing a secondary aesthetic use in this embodiment as pond or aquarium decoration. With the attachment of camouflaging elements 1300 and 1301, filter system 103 takes on the appearance of a turtle in this example. In some embodiments, the contours of filter system 103 may be cosmetically modified to enhance visual continuity between it and the attached camouflaging elements without departing from the scope of the invention. In this example, the filter compartment of filter system 103 is formed or shaped more or less to conform to the shape of a turtle underbody and the stands 105 and 106 are shaped like pairs of legs.

The downward facing intake design of filter system 103 enables the addition of camouflaging elements to the top and sides of the filter enclosure without affecting the primary filtering function of filter system 103. In this example, the camouflaging elements 1300 and 1301 occupy the entire top surface and partially cover the sides of filter system 103. Water flows unobstructed into the downward facing intake 107, passes through the filter media (not shown) and out toward the external pump through egress 108. In this example, filter 103 in the form of a pond turtle sits on pond floor 102 and may be totally or partially submerged. In this case, it is partially submerged as indicated by water line 101. It is noted herein that a pump and optional UV sterilizing unit may be provided as was illustrated in FIG. 5 described above.

The implementation of filter system 103 may be modular so that a user may change the look of filter system 103 to another pond animal like an alligator, a goose, a large bullfrog, a large fish, or the like by replacing the camouflaging elements. The camouflaging elements may also involve filter stands. For example, the stands may resemble fish fins for the embodiment of the fish and so on. In another embodiment, the modular units may be in the form of different structures or artistic forms like rock formations, islands, boats, or other unique artistic pieces. The essential function and principle features of the filter system remain unchanged with different implementations.

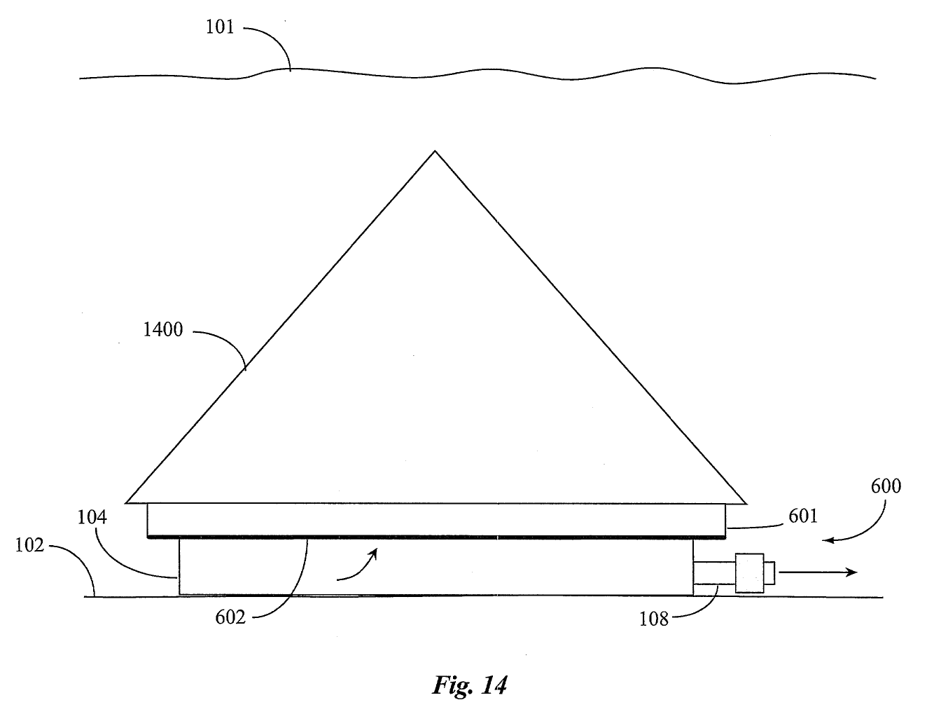

In a variation of filter system 600 shown in FIG. 14, the intake may be provided within the perimeter of the camouflaging element rather than in the underside of the filter compartment. In this case filter system 600 is performing a secondary decorative use as a pyramid. The camouflaging element 1400 is attached to cover 601 that contains the downward facing intake. Filter stands may or may not be utilized. Also in this case, retaining clips may be used to connect interchangeable camouflaging elements to cover 601. In other embodiments, cover 601 may be formed into a camouflaging element that integrates downward facing intake 602 into its perimeter such that the inner edge of intake 602 fits snugly with the outer edge of filter compartment 104 containing the filter media. In this respect all of the different camouflaging element implementations would contain intakes and would be dimensioned to fit compartment 104 in the same fashion using the same modular fastener system.

In one embodiment where the intake is provided about the perimeter of an overhang, the intake may have solid structure like one or more oblong sleeve or tube connectors that may snap into openings provided in the filter compartment top leading to the filter media. The throats of these tubes may be constricted to provide a venturi effect for water flow into the filter media. There are many design possibilities that may be envisioned without departing from the spirit and scope of the present invention.

Alternate embodiments of integrated filter systems 500 and 1000 may serve secondary functional and decorative uses in a similar manner to their non-integrated counterparts 103 and 600 respectively.

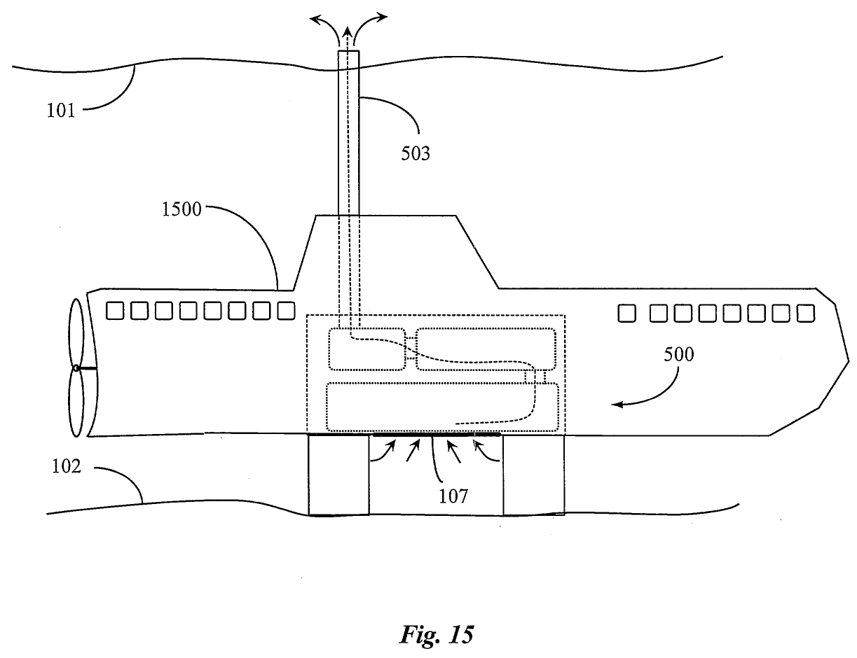

FIG. 15 is a side view of another embodiment of filter system 500 performing a secondary decorative function as a submarine. Camouflaging element 1500 may be attached to filter system 500 in a modular way using removable fasteners such as clips, screws, Velcro or similar devices. Water from egress 503 may be partially diverted to operate artistic or functional kinetic structures that are part of the camouflaging element. In this example, the propeller at the tail end of the submarine may spin for visual effect and provide water circulation.

The illustrated embodiment in FIG. 15 has filter stands and rests on bottom 102 of the pond or aquarium beneath the surface of the water 101. In one embodiment, water egress 503 of filtering system 500 represents a periscope of the submarine. Again, as in other embodiments, water is drawn in through a downward facing intake 107 through the filter media, UV sterilizer, and pump and finally expelled through egress 503. The downward facing intake design enables the top and sides of filter system 500 to be fully enclosed by the camouflaging element. In another embodiment, camouflaging element 1500 may be adapted with a ballast system that fills with water to submerge the system and then empties periodically to cause the system to surface mimicking a real submarine. In that case filter stands would not be required, since the support for the system is the water itself.

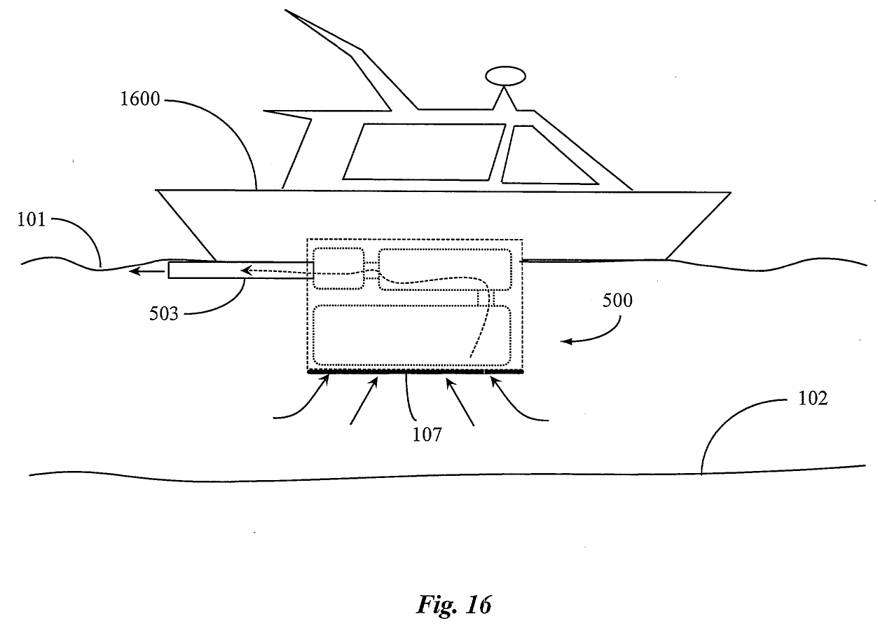

FIG. 16 is an elevation view of yet another embodiment of the present invention. System 500 is attached to a floating camouflaging element that is shaped like a boat. In this case, top water line 101 is the support surface. As with previously described embodiments performing a secondary aesthetic function, this instance draws water into a downward facing intake 107, passes it through filter media, an optional UV sterilizer, pump and finally out through egress 503. In this case, the filtered water exiting the system provides thrust allowing this embodiment to move. This boat may be tethered to some structure in the pond, or it may be allowed to move freely. In some embodiments, the elevation of intake 107 over pond or aquarium bottom 102 may be adjusted by lowering or raising the intake assembly relative to the floating camouflaging element. In other embodiments, the height adjustment may be made by changing the buoyancy of the camouflaging element. Other types of floating decor may be provided in place of a boat dressing without departing from the spirit and scope of the present invention.

It will be apparent to one with skill in the art that the filter system of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention. For example, pumps may be external or onboard the filter system. Outlet devices may be side mounted leading to a pump or top mounted leading from a pump. Filter implementations may be provided that are modular, including different types of artistic designs. In light of the embodiments described above, the claims should be afforded the broadest interpretation under examination. The spirit and scope of the present invention should be limited only by the claims that follow.

What is claimed is:

1. A filter system comprising:
a filter compartment enclosing a filtering media;
a downward facing intake into said filter compartment;
a means for positioning said downward facing intake below the surface of a fluid at a predetermined distance above a floor of said fluid's container, said predetermined distance is sufficiently great to reduce suction force on said floor immediately below said downward facing intake, said suction force is reduced to less than the force of gravity affecting settled matter resting on said floor immediately below said downward facing intake; and
an outlet from said filter compartment for connection to a suction source.

2. The filter system of claim 1 wherein said floor is the bottom of a pond.

3. The filter system of claim 1 wherein said floor is the bottom of an aquarium.

4. The filter system of claim 1 wherein said means for positioning said downward facing intake is one or more supporting members placed between said downward facing intake and said floor.

5. The filter system of claim 1 wherein said means for positioning said downward facing intake is suspension of said downward facing intake from a buoyant device.

6. The filter system of claim 1, further including a cover positioned over said filter compartment, the overhang of said cover serves as said downward facing intake.

7. The filter system of claim 6 wherein said downward facing intake integrated within said cover includes at least one connector that snaps into at least one opening in said filter compartment.

8. The filter system of claim 1, further including a means for attaching camouflaging elements to said filter compartment.

9. The filter system of claim 1, further including elements for camouflaging the filter system.

10. The filter system of claim 9 wherein said elements represent an animal, plant, rock formation, landmark, natural phenomenon, landscape, vehicle, building, icon, logo, human, artistic sculpture, piece of art, or any combination thereof.

11. The filter system of claim 1, further including a pump connected to said outlet.

12. The filter system of claim 11, further including a UV sterilizer connected to said pump.

13. A method for filtering comprising:
(a) providing a filter media compartment, said filter media compartment contains filtering media,
(b) providing a downward facing intake leading into said filter media compartment,
(c) providing an outlet leading out of said filter media compartment,
(d) positioning said downward facing intake below the surface of a fluid and above a floor of said fluid's container at a predetermined distance, said predetermined distance is large enough to avoid creating a suction force strong enough to draw in settled matter resting on said floor immediately below said downward facing intake, and
(e) connecting the outlet to a suction source.

14. The method of claim 13 wherein in act (d), said floor is the bottom of a pond.

15. The method of claim 13 wherein in act (d), said floor is the bottom of an aquarium.

16. The method of claim 13 wherein in act (b), said downward facing intake is integrated into a cover that attaches over said filter media compartment.

17. The method of claim 13 wherein in act (d), said downward facing intake is elevated above said floor at said predetermined distance by one or more members.

18. The method of claim 13 wherein in act (d), said downward facing intake is suspended from a buoyant device above said floor at said predetermined distance.

19. The method of claim 13, wherein in act (e), said suction source is a pump.

20. The method of claim 13, wherein in act (a), the shape of said filter media compartment represents an animal, plant, rock formation, landmark, natural phenomenon, landscape, vehicle, building, icon, logo, human, artistic sculpture, piece of art, or any combination thereof.
